(19) United States
(12) Patent Application Publication
(10) Pub. No.: US 2014/0049476 A1
(43) Pub. Date: Feb. 20, 2014

(54) ELECTRONIC DEVICE CASE WITH TOUCH SENSITIVE INPUT

(71) Applicant: Oleksiy Bragin, Moscow (RU)

(72) Inventor: Oleksiy Bragin, Moscow (RU)

(21) Appl. No.: 13/584,922

(22) Filed: Aug. 14, 2012

(51) Int. Cl. G06F 3/041

(52) U.S. Cl. 345/173

(57) ABSTRACT

Disclosed is a case for an electronic device such as a wireless phone, tablet computer, media player electronic book reader or the like. The case can include a body portion configured to receive the electronic device and provide a removable cover for the electronic device. The case can also include at least one touch sensitive input device disposed on an exterior surface of the body portion.

Embodiments relate generally to device cases, and more particularly, to device cases having one or more touch sensitive input devices.

Conventional electronic device cases may be passive coverings for protecting an electronic device held within a case. Many portable electronic devices, such as wireless phones tablets, media players, electronic book players and the like have touch sensitive screens. A limitation of these conventional devices may be the amount of surface area available for use as a touch device. Also, another limitation may be that a user may at least partially obstruct the screen of a device when interacting with a touch sensitive display.

Embodiments were conceived in light of the above-mentioned limitations, among other things.

Some implementations can include a case having a body portion configured to receive an electronic device and provide a removable cover for the electronic device. The case can include at least one touch sensitive input device disposed on an exterior surface of the body portion.

The case can also include an interface configured to transmit a signal from the at least one touch sensitive input device to the electronic device. The interface can include one or more of a universal serial bus interface, a wireless universal serial bus interface, a Bluetooth interface, a serial data interface and a parallel data interface.

The at least one touch sensitive input device can include two (or more) touch sensitive input devices. The at least one touch sensitive input device can be disposed on a back exterior surface of the case opposite from a front of the case where a screen of the electronic device is viewable. The at least one touch sensitive input device can include one or more of a resistive device, a surface acoustic wave device, a capacitive device, an infrared device, an optical imaging device, a dispersive signal device and an acoustic pulse recognition device. The capacitive device can include one or more of a surface capacitive device, a projected capacitive device, a mutual capacitance and a self-capacitance device.

The case can include a power source (e.g., battery, capacitor, power connector, or the like) configured to power the at least one touch sensitive input device and the interface. The at least one touch sensitive input device can include an edge portion configured to provide tactile feedback to a user in locating the at least one touch sensitive input device.

### BRIEF DESCRIPTION OF THE DRAWINGS

FIG. 1 shows a diagram of an example device case with a touch sensitive input device in accordance with at least one embodiment.

FIG. 2 shows a diagram of an example device case with a plurality of touch sensitive input devices in accordance with at least one embodiment.

### DETAILED DESCRIPTION

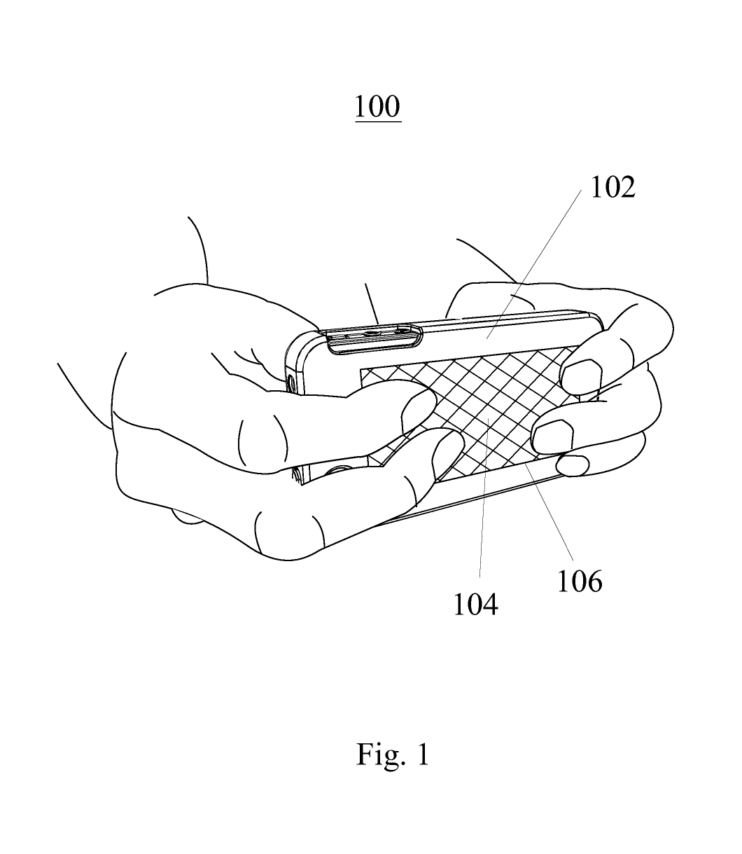

As shown in FIG. 1, an electronic device case 100 can include a body portion 102 at least partially covering the electronic device. The case can include a touch sensitive input device 104 that can have an edge portion 106 that is configured (e.g., raised) to provide a user with tactile guidance as to the location of the touch sensitive input device 104.

The electronic device can include a wireless phone (iPhone, Droid, Blackberry, Palm OS device or the like), a tablet device (iPad or the like), a media player (iPod or the like), an electronic book reader (Kindle, Nook or the like), laptop computer, notebook computer or the like.

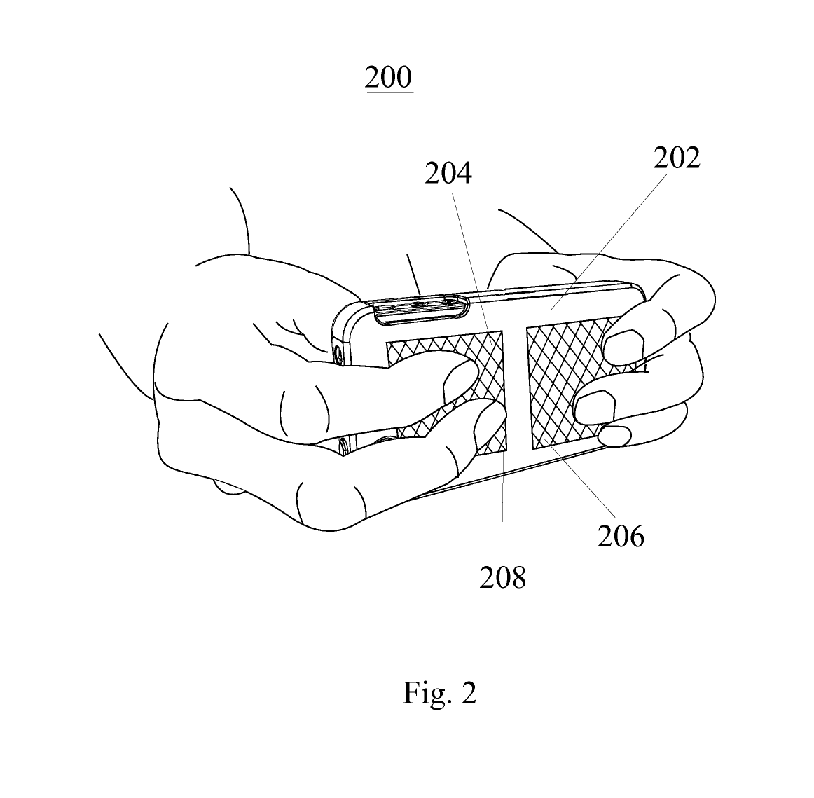

FIG. 2 shows an example case system 200 having a body portion 202, a first touch sensitive input device 204, a second touch sensitive input device 206. Each touch sensitive input device can have an edge (e.g., 208) that provides tactile feedback to a user as to the location of the respective touch sensitive input devices.

An embodiment can include an interface (e.g., Bluetooth, USB, wireless USB, wired or wireless connection) for transmitting a signal from the touch sensitive input device(s) to the electronic device. The case can also include a processor and/or a power source. The processor can be used to collect signals from the touch sensitive input device(s) and transmit the signals to the electronic device via the interface. The power source can be used to power the touch sensitive input device(s), processor and/or interface.

The touch sensitive input device can include one or more of a resistive device, surface acoustic wave device, capacitive device (e.g., surface capacitive, projected capacitive, mutual capacitance, self-capacitance, or the like), infrared device, optical imaging device, dispersive signal device, acoustic pulse recognition device or the like.

An embodiment can also include a system having one or more touch sensitive input devices on an exterior of a case and a software program stored on a nontransitory computer readable medium and configured to be executed (or run) on the electronic device. The software program can be configured to provide an image on a display of the device of a location (or locations) of a user fingers on the touch sensitive input devices. The image or images can be partially transparent so as to permit the user to see both a location of the fingers on the touch sensitive input device(s) and to see the screen image simultaneously.

While the examples above show one and two touch sensitive input devices, it will be appreciated that an embodiment can include more than two separate touch sensitive input devices (e.g., one device for each finger of each hand). The separate touch sensitive input devices can be assigned the same or different functions (e.g., keyboard keys, game controller inputs or the like). Also, in addition to being disposed on a back exterior surface of the case, one or more touch sensitive input devices can be placed on other exterior surfaces of the case.

It is, therefore, apparent that there is provided, in accordance with the various embodiments disclosed herein, a device case having at least one touch sensitive input device disposed on an exterior of the case.

While the invention has been described in conjunction with a number of embodiments, it is evident that many alternatives, modifications and variations would be or are apparent to those of ordinary skill in the applicable arts. Accordingly, Applicants intend to embrace all such alternatives, modifications, equivalents and variations that are within the spirit and scope of the invention.

What is claimed is:

1. A case comprising:
a body portion configured to receive an electronic device and provide a removable cover for the electronic device; and
at least one touch sensitive input device disposed on an exterior surface of the body portion.

2. The case of claim 1, further comprising an interface configured to transmit a signal from the at least one touch sensitive input device to the electronic device.

3. The case of claim 1, wherein the at least one touch sensitive input device includes two touch sensitive input devices.

4. The case of claim 2, wherein the interface includes one or more of a universal serial bus interface, a wireless universal serial bus interface, a Bluetooth interface, a serial data interface and a parallel data interface.

5. The case of claim 1, wherein the at least one touch sensitive input device is disposed on a back exterior surface of the case opposite from a front of the case where a screen of the electronic device is viewable.

6. The case of claim 2, further comprising a power source configured to power the at least one touch sensitive input device and the interface.

7. The case of claim 1, wherein the at least one touch sensitive input device includes one or more of a resistive device, a surface acoustic wave device, a capacitive device, an infrared device, an optical imaging device, a dispersive signal device and an acoustic pulse recognition device.

8. The case of claim 7, wherein the capacitive device includes one or more of a surface capacitive device, a projected capacitive device, a mutual capacitance and a self-capacitance device.

9. The case of claim 1, wherein the at least one touch sensitive input device includes an edge portion configured to provide tactile feedback to a user in locating the at least one touch sensitive input device.
